(19) United States
(12) Patent Application Publication
(10) Pub. No.: US 2025/0116158 A1
(43) Pub. Date: Apr. 10, 2025

(54) PORTABLE STRUCTURE FOR ASCENDING TO AND DESCENDING FROM INACCESSIBLE PLACES WITH A SELF-SUPPORTING WORK PLATFORM

(71) Applicant: ARMOSEN, S.L., BILBAO (BIZKAIA) (ES)

(72) Inventors: Koldobika Iñaki UNZUETA GARMENDIA, BILBAO (BIZKAIA) (ES); Izar UNZUETA ALESANCO, BILBAO (BIZKAIA) (ES); Sire UNZUETA ALESANCO, BILBAO (BIZKAIA) (ES)

(21) Appl. No.: 18/832,310

(22) PCT Filed: Jan. 11, 2023
(86) PCT No.: PCT/ES2023/070012

§ 371 Date: Jul. 23, 2024

(30) Foreign Application Priority Data
Jan. 28, 2022 (ES) U202230136

(51) Int. Cl. E06C 1/393; E06C 7/12; E06C 7/16; E06C 7/18; E06C 7/42; E06C 7/50

(52) U.S. Cl. CPC E06C 1/393; E06C 7/12; E06C 7/16; E06C 7/423; E06C 7/50; E06C 7/182

(57) ABSTRACT

A portable structure for ascending to and descending from inaccessible places with a self-supporting work platform, structure being of the type formed by three legs, one of which is a length of ladder, the legs converging at the top where the platform is situated and where the three legs are joined, consisting of the corresponding supports and the corresponding lengths of ladder, wherein each of the three legs is linked to the platform at two connection and bracing points, distanced from each other, with angle mounting element being provided at one of the two connection points for each leg to prevent the legs from twisting and to establish a triangular distribution of forces; and wherein the portable structure thus formed does not need a bracing structure in the middle area between the different legs.

### TECHNICAL FIELD

The present invention relates to the sector of portable structures for ascending to and descending from inaccessible places, such as stepladders, ladders, or scaffoldings, and specifically to portable structures provided with a work platform, for the ladder user, at which platform there converge legs formed by one or more lengths of ladder for accessing the work platform and one or more supports.

For simplicity in the description, portable structures will be identified hereinafter as portable ladder, although everything that is said about said structures is applicable to ladders and scaffoldings with three support legs.

### STATE OF THE ART

Portable ladders or stepladders can be divided into two groups:

Supportable ladders or stepladders. These are ladders that are by themselves unstable and must be supported on the element to be ascended: wall, façade, etc.

Self-supporting ladders or stepladders. These ladders are capable of supporting themselves and the most common ladder within this group is the so-called scissor ladder. In many cases, a self-supporting ladder can be used as a supportable ladder.

Among this type of so-called self-supporting ladder, an embodiment whereby the so-called support legs are made up of three legs converging at the top of the ladder is known. The three legs are formed by one or more lengths of ladder and one or more supports.

Patents FR344595 and GB190405121 show a structure with three lengths of ladder acting as legs, but both solutions do not have a work platform.

Patent US2015345219 shows a structure formed by two supports and a length of ladder, each of the three legs being rotationally connected to a small upper triangle; such that each element is connected in an articulated manner to one of the sides of the small upper triangle which is not a work platform itself. A similar solution, but with three lengths of ladder, is disclosed in U.S. Pat. No. 5,685,391 and GB2341883.

Patent DE2141074 shows a structure also formed by two supports and a length of ladder which incorporates a seat at the top thereof, instead of a work platform.

An upper work platform and three support legs are disclosed in the solution of EP1079062 which shows a ladder with three support legs of which two are supports themselves and the third is a length of ladder with rungs that end in the upper portion in a rectangular work platform, with a handrail.

Like the two supports, the length of ladder has a central tubular element, i.e., with a tubular embodiment having a circular cross-section; such that the connection between the three legs and the platform is carried out through an articulation pin.

However, this solution poses a fundamental problem inherent to ladders with three support legs, i.e., the twisting of the support legs and subsequent falling of the ladder, which entails the risk of causing serious accidents to the users.

This problem is exacerbated when the ladder is set up on floors that do not offer a suitable friction for the leg support points and reaches very dangerous extremes when the ladder is installed on slippery floors. Evidently this solution cannot be applied for a ladder having a rolling element at at least one of the points of its three support legs contacting with the floor.

On the other hand, this solution requires means to limit the degree of opening of the support legs. In fact, in an attempt to prevent twisting effects and limit the opening angle of the support legs of the ladder, it is necessary to resort to flange-like frames that are connected to the three support legs, defining a structure in the form of a contouring stiffening collar, in a horizontal plane parallel to the floor and at the mid-height of the ladder. This solution, in addition to not being completely effective on slippery floors or with rolling supports, implies complicating the embodiment of the ladder, due to the need to incorporate elements making up the stiffening collar or collars; furthermore, they make it very complicated to assemble and stow away the ladder and increase its weight, which is very negative for a portable manual ladder.

Moreover, in order to simplify the deployment and the stowing away of the ladder, solutions have been resorted to whereby each flange-type element that connects two support legs has a compass-like embodiment that allows it to be deployed and stowed away in an articulated manner, without having to disassemble it, but this embodiment further complicates the embodiment of the ladder in that it requires hinges for the compasses and providing said hinges with safety means that prevent their involuntary closure, in addition to also entailing an added weight.

Another drawback of the known solutions lies in the fact that the opening angle of the legs is fixed and this translates into the impossibility of assembling the ladder in places where the fixed angle does not allow overcoming obstacles, such as a nearby wall, an obstacle that must be arranged below the ladder, etc.

On the other hand, these solutions do not offer suitable stiffness in the connection between the support legs and the work platform, which again results in insecurity for the user.

In view of the described drawbacks of currently existing solutions, it is clear that a solution is required.

### OBJECT OF THE INVENTION

For the purpose of meeting this objective and solving the mentioned technical problems existing up until now, in addition to providing additional advantages that will be seen below, the present invention relates to a portable structure for ascending to and descending from inaccessible places, such as stepladders, which is provided with three legs that converge at the top where a work platform having the characteristic of being self-supporting is situated. The work platform physically or theoretically defines at least three lines, in relation to which there are assembled the three legs, consisting of the support or the corresponding supports and the length of ladder or the corresponding lengths of ladder, with the particularity that each of the three legs is connected to the work platform at at least two points distanced from each another, thereby providing for each leg two connection and bracing points separated from each another, with there being an angle mounting means at at least one of the two points, which allows preventing the legs from twisting, even on slippery floors, and furthermore allows establishing a triangular distribution of forces.

In this way, the portable structure thus formed does not need to have, in the middle area thereof, flange elements which establish a bracing collar between the different legs at mid-height, for the platform to be self-supporting.

Furthermore, and with this solution, the legs can occupy positions of variable angle and the user can fix the angles at his/her own discretion, which allows the ladder to be assembled next to obstacles such as a wall and to pass over obstacles such as a stone, a barrier, a car, etc.

### DESCRIPTION OF THE FIGURES

FIG. 1 shows a perspective view of a portable structure formed by a mobile ladder that is provided with the solution object of the present invention.

FIG. 2 is a front elevational view of the ladder of the preceding figure.

FIG. 3 shows the top plan view of the ladder of FIGS. 1 and 2.

FIG. 4 corresponds to a perspective view of a stowed-away ladder with eight rungs made according to the present invention.

FIGS. 5 and 6 are the profile and front elevational views, respectively, of the ladder of FIG. 4.

FIG. 7 corresponds to a perspective view of a stowed-away ladder with twelve rungs made according to the present invention.

FIGS. 8 and 9 are the profile and front elevational views, respectively, of the ladder of FIG. 7.

FIG. 10 is a perspective view of the work platform (1).

FIGS. 11, 12, and 13 are the top plan, profile, and bottom plan views, respectively, of the platform (1) of FIG. 10.

FIG. 14 is a perspective view showing a fragmented embodiment variant of the work platform (1).

FIG. 15 is a perspective view of the part of the work platform (1) of a ladder made according to the present invention, to enable viewing the disk (1.10) with openings and the ratchet (1.8), the latter being in the closed position corresponding with the working position of the ladder.

FIG. 16 shows an enlarged detail of the part of the disk (1.10) and of the ratchet (1.8) in the closed position thereof corresponding with that of the preceding figure.

FIG. 17 is a perspective view such as that of FIG. 15, but with the ratchet (1.8) in the raised position.

FIG. 18 shows an enlarged detail of the part of the disk (1.10) and of the ratchet (1.8), with this latter being in the raised position such as in the preceding figure.

FIG. 19 is a perspective view of the work platform (1) viewed from the bottom thereof, with the rotating structures (1.6) folded below the work platform (1); whereas the journals (1.7) of the ladder leg (3.1) are deployed.

FIG. 20 is a perspective view such as that of FIGS. 15 and 17, but with the ratchet (1.8) in the stowed-away position.

FIG. 21 shows an enlarged detail of the part of the ratchet (1.8), with the latter being in the closed position, such as in the position depicted in FIGS. 15 and 16, but according to a practical embodiment variant, in which the ratchet (1.8) incorporates a filiform spring (1.21); whereas the journals (1.7) incorporate fixing means (1.20) which can be adjusted to adapt the journals (1.7) to the dimensions of longitudinal members of conventional ladder legs (3.1).

FIG. 22 shows a perspective view of a detail of the platform (1), to enable viewing the central opening (1.23) thereof and the accessories (1.7.1) of the journals (1.7).

FIG. 23 is a view such as that of FIG. 1 but now incorporating two quick fixing mechanisms (5) in the leg (3.2).

FIG. 24 is a perspective view of a detail showing the inner part of each quick fixing mechanism (5), with one of the two metal plates (9) having been removed to enable viewing the inner elements of the quick fixing mechanism (5).

FIG. 25 is an elevational view in which a quick fixing mechanism (5) can be seen, arranged in relation to the tubular lengths (3.4 and 3.5).

### DETAILED DESCRIPTION OF THE INVENTION

The present invention relates to a portable structure for ascending to and descending from inaccessible places, such as stepladders, which structure is provided with a work platform (1) which, as will be seen below, is self-supporting. The work platform (1) is arranged on three legs (3.1, 3.2, and 3.3) which converge at the top towards the platform and define at the bottom respective points (4) for contact with the floor.

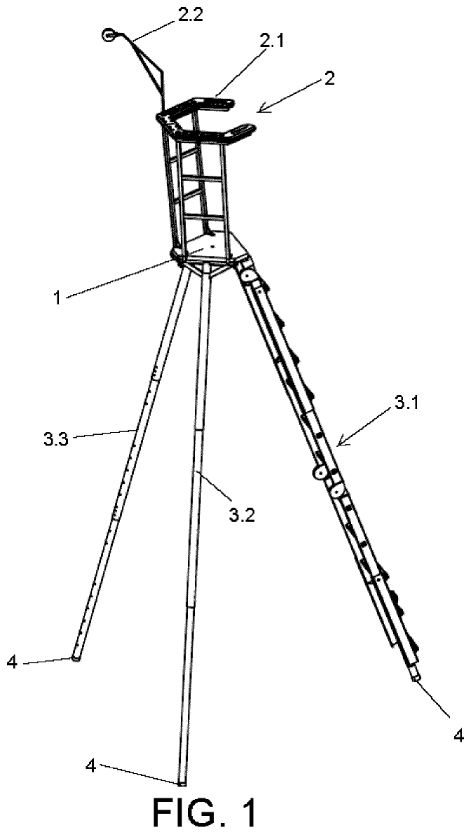

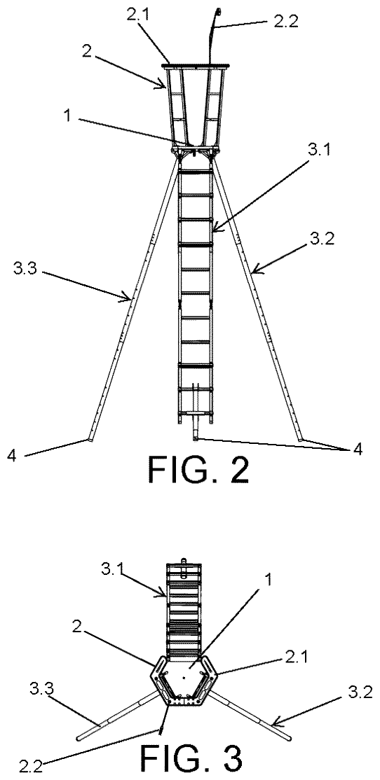

As can be seen in FIGS. 1, 2, and 3 and according to a non-limiting practical embodiment, the work platform (1) is complemented with a railing (2), provided with a handrail (2.1) the purpose of which is to protect the person or persons on the work platform (1) from the risk of falling accidentally into the void. This railing (2) can be complemented with other secondary means (2.2), and preferably removable auxiliary elements, such as, for example, to perform the functions such as for hanging tools, providing electrical wiring, assembling a winch-type solution for raising or lowering weights, or any other means that the operator on the work platform (1) may need.

According to the non-limiting practical embodiment depicted in the attached figures, at least one of the legs (3.1, 3.2 or 3.3), specifically in this case the one identified with reference number (3.1), is a ladder formed by two longitudinal members and the corresponding rungs; whereas the legs (3.2 and 3.3) are simple supports, but obviously two of the three legs and even all three legs can be ladders, for which reason it is said that at least one of the three legs (3.1, 3.2 and/or 3.3) is a ladder to allow going up and coming down from the work platform (1).

The embodiment with three legs (3.1, 3.2, and 3.3) may correspond with any of the conventional solutions known up until now. In this sense, the ladder leg (3.1) can have a variable number of rungs; can be configured by a single length or two or more lengths; may have a stiff, articulated, or telescopic structure, etc. Moreover, the ladder leg (3.1) may have an embodiment formed, instead of two longitudinal members and the corresponding rungs extending transversely between them, by a single central longitudinal member with the rungs going through same.

The same occurs with the simple support legs (3.2 and 3.3), which can be a single piece or determined by several lengths articulated to each another or with a telescopic assembly, etc.

The points (4) for contact with the floor may also have any conventional embodiment that is known up until now or that may arise in the future, consisting of the legs (3.1, 3.2, and 3.3) themselves or of auxiliary elements, such as rubber ferrules, or of rolling means or even combination of these elements.

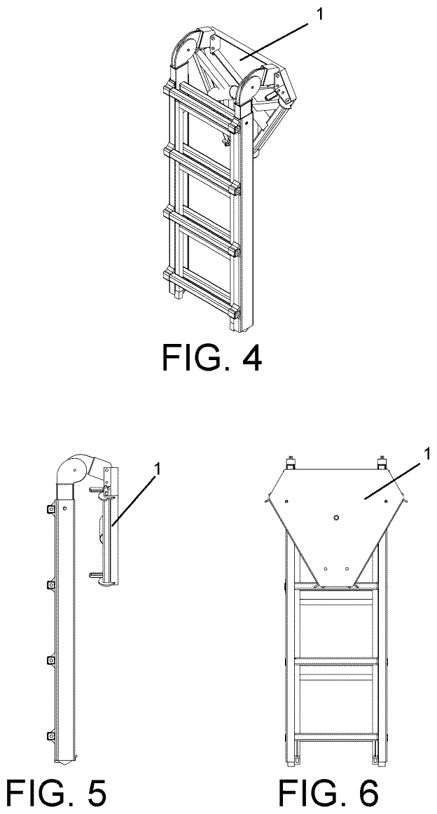

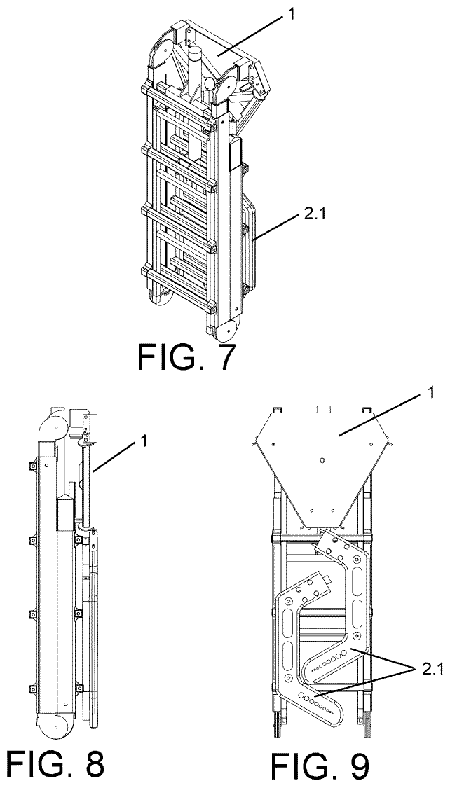

FIGS. 4, 5, and 6 depict a stowed-away ladder with eight rungs; whereas the ladder of FIGS. 7, 8, and 9 is with twelve rungs, in correspondence with the one depicted in FIGS. 1, 2, and 3. As can be seen in FIGS. 7 and 9, the actual structure of the ladder can be prepared such that, some or all the auxiliary elements, such as the railing (2) and its handrail (2.1), can be folded thereon.

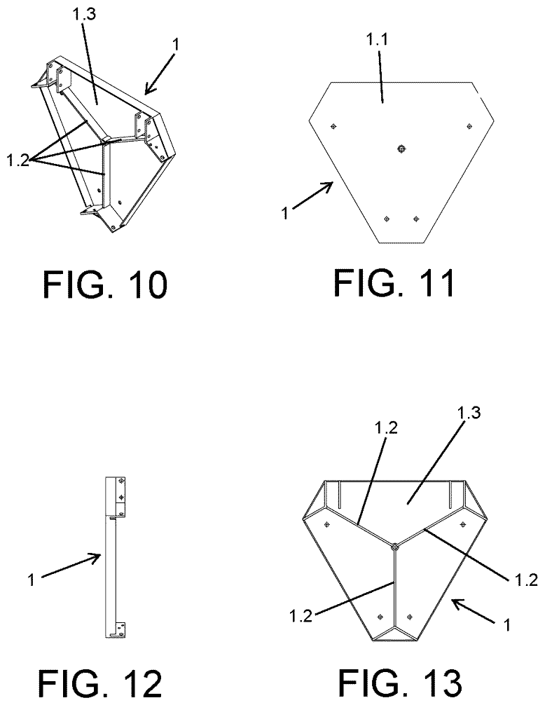

FIGS. 10 to 13 show a possible practical embodiment of the work platform (1), whereby it preferably adopts a triangular base configuration with truncated vertices, defining a flattened upper part (1.1) on which the user will be supported and a bottom (1.3) provided with stiffening ribs (1.2) which are optional, depending on the thickness and the material with which the work platform (1) is made.

The top (1.1) of the work platform (1) may have its own anti-slip finish, or by means of an auxiliary covering; whereas the stiffening ribs (1.2), if present, will have a preferred but non-limiting embodiment, shown in FIGS. 10 and 13, with a radial arrangement at 120° with respect to each other.

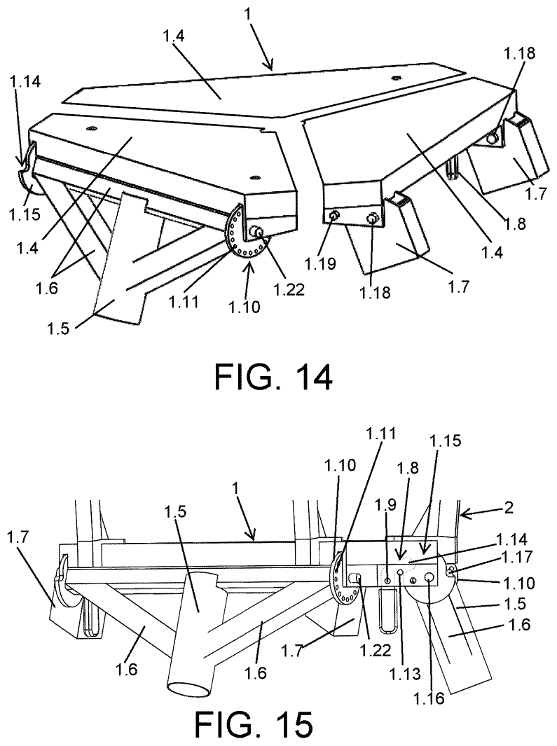

Moreover, FIG. 14 shows how the work platform (1) may have a fragmented embodiment, preferably fragmented in three parts identified with reference numbers (1.4); such that each of the three parts (1.4) is connected to one of the legs (3.1, 3.2 or 3.3). With this embodiment, the three legs (3.1, 3.2, and 3.3) can be separated from each another and stored, one next to the other, in a paraxial arrangement which occupies as little space as possible during the ladder folding and storage or transport phase.

As can be seen in FIG. 14 and according to a possible non-limiting practical embodiment, the work platform (1) has, on each of its sides linked to one of the legs (3.2 and 3.3), a rotating structure (1.6) preferably having a triangular configuration with an inverted vertex that determines two V-shaped lengths connected to a horizontal length.

The rotating structure (1.6) incorporates a journal (1.5) at the vertex of the V-shaped lengths to enable the removable assembly of the legs (3.2 and 3.3).

The platform (1) has, on the side linked to the ladder leg (3.1), two journals (1.7), so as to also allow a removable assembly of the ladder leg (3.1). Moreover, with this embodiment, the legs (3.1, 3.2 and/or 3.3) may consist of conventional elements available on the market, provided that the journals (1.5 and 1.7) adapt to the dimensions of the conventional elements or incorporate, as will be seen below, regulation and adjustment means to adapt to the measurements of such conventional elements.

According to a preferred practical, but non-limiting, embodiment, each of the two journals (1.7) for the ladder leg (3.1) can rotate in an articulated manner about a rotating shaft (1.18) to transition from the deployed position or working position to the stowed-away or folded position, in which they are arranged below the platform (1).

This established that, to the extent possible, simple, single-length or extendible stepladders will be placed at an angle of between 70.5° and 75.5° with respect to the horizontal of the floor. Respecting this measurement and in relation to at least one of the two journals (1.7) for the ladder leg (3.1) there is, next to the rotating shaft (1.18) thereof, a pin (1.19), see FIG. 14, acting as a stop; such that it limits the opening of the ladder leg (3.1) to a value preferably of about 70°.

In terms of the simple support legs (3.2 and 3.3), there are means to enable fixing their opening position in a 360° path. To that end and according to a preferred practical, but non-limiting, embodiment, such means consist of a disk (1.10) having a plurality of openings (1.11) distributed circumferentially around the rotating shaft (1.22) of the disk (1.10).

As can be seen in FIG. 15, the mentioned disk (1.10) is assembled at one of the ends of the horizontal length of the rotating structure (1.6) bearing the journal (1.5) and can rotate with respect to same about the rotating shaft (1.22) of the rotating structure (1.6).

In this way, by means of a pin that is not depicted and by passing it through one of the openings (1.11), a multiplicity of radial positions of the legs (3.2 and 3.3), as many as there are openings (1.11) in the disk (1.10), can be fixed, allowing the legs (3.2 and 3.3) to be arranged and fixed 360°.

This solution consisting of a pin can be replaced by any of the known fixing solutions, such as an embodiment that acts automatically, for example, by means of a solution consisting of a ball pushed by a spring.

In this way, the legs (3.2 and 3.3) can be fixed, in their deployed positions, in a 360° angular path.

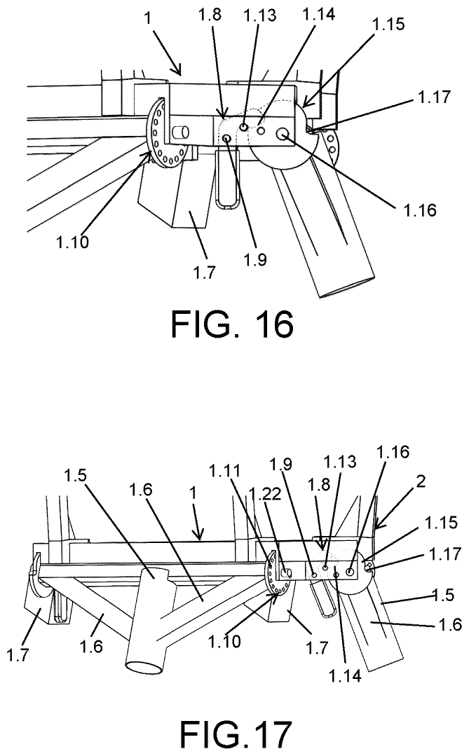

As can be seen in FIGS. 15 and 16, in relation to the other rotating shaft of the rotating structure (1.6), identified with reference number (1.16), there is arranged a cam piece (1.15) having in the periphery thereof recesses, preferably two in number and identified with reference numbers (1.14 and 1.17).

In relation to this cam piece (1.15) there is arranged a ratchet (1.8) which can rotate about a shaft (1.9) to a stable position limited by a stop pin (1.13).

In the deployed position of the ladder which corresponds with the working position and is depicted in FIGS. 15 and 16, the ratchet (1.8) occupies a closed position in which it is housed in the recess (1.14) of the cam piece (1.15), fixing this position.

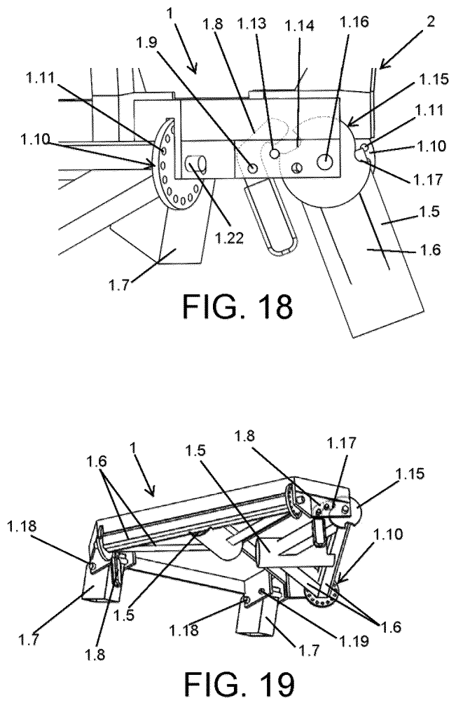

It can be seen in FIGS. 17 and 18 how the ratchet (1.8) has been manually raised, taking it out of the recess (1.14); such that, having previously released the fixing established through the disk (1.10), the swinging movement of each of the two rotating structures (1.6) about the shafts (1.16 and 1.22) is then allowed and with them, the movement of the legs (3.2 and 3.3) if they are assembled in the journals (1.5), both for changing the angle of support on the floor, and for bringing them from the working position to the stowed-away position or vice versa.

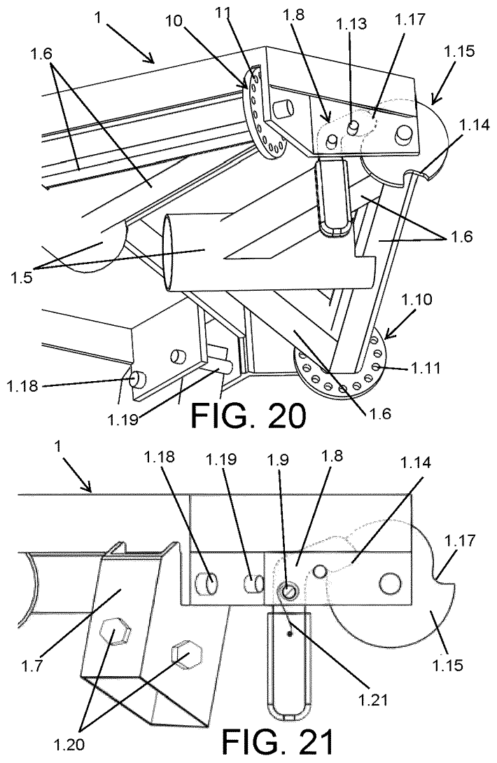

FIGS. 19 and 20 show how the two rotating structures (1.6) occupy the stowed-away position in which they are folded below the work platform (1). As can be seen in these two FIGS. 19 and 20, in the stowed-away position of the two rotating structures (1.6), the ratchet (1.8) is housed in the other recess (1.17) of the cam piece (1.15).

With respect to the two journals (1.7) of the ladder leg (3.1), in addition to the fact that there is, in relation to one of them, the stop (1.19), it has been envisaged for the journals to also incorporate a solution consisting of a ratchet (1.8) and a cam piece (1.15) such as that described above which can be installed in relation to one of or to the two journals (1.7).

FIG. 21 depicts a practical embodiment variant whereby, in relation to each ratchet (1.8) there are arranged spring-type elastic means (1.21) or the like which maintain the ratchet (1.8) in a stable contact position on the cam piece (1.15). According to the non-limiting practical embodiment depicted in said FIG. 21, the elastic means (1.21) are made up of a filiform spring, assembled in the rotating shaft (1.9) of the ratchet (1.8).

According to what has been described up until now, the portable structure for ascending to and descending from inaccessible places, such as a ladder, has three legs (3.1, 3.2, and 3.3) which converge in the upper portion in the work platform (1) and of which at least one of said legs is a ladder leg (3.1) to enable going up or coming down from said work platform (1); whereas, in such case, the other two legs (3.2 and 3.3) are support legs.

The ladder leg (3.1) has, in relation to at least one of or the two rotating journals (1.7) in which it is assembled with possibility of rotation with respect to the work platform (1), a stop (1.19) that limits its opening angle, and at least in relation to the other journal (1.7) a solution consisting of a ratchet (1.8) that can occupy at least three positions, a closed position corresponding with the deployed or working position of the ladder leg (3.1), another raised position, in which it allows the ladder leg (3.1) to rotate, and the third stowed-away position corresponding with the aforementioned journals (1.7) being stowed away below the work platform (1).

In turn, each support leg (3.2 or 3.3) is assembled in a rotating structure (1.6) which can rotate at two points with respect to the work platform (1) and has, in relation to at least one of the two rotating ends of this rotating structure (1.6), fixing means formed by a disk (1.10) and said end, the opposite one or both, may optionally have a solution consisting of a ratchet (1.8).

In this way, each ladder leg (3.1) may have, in relation to each of the two rotating journals (1.7), a stop (1.19) for limiting its opening angle and a fixing ratchet (1.8). According to a practical embodiment variant, each ladder leg (3.1) may have a stop (1.19) in relation to one of the journals (1.7) and a ratchet (1.8) in correspondence with the other journal (1.17).

Each of the two support legs (3.2 or 3.3) has, in relation to at least one of the two articulated ends of the rotating structure (1.6) thereof, a disk (1.10) for fixing the angle that the leg (3.2 or 3.3) must occupy with respect to the floor and, optionally, as a practical embodiment variant, a disk (1.10) in relation to one of the rotation points thereof and a solution consisting of a ratchet (1.8) in relation to the other rotation point.

In any of these possible embodiments, each leg (3.1, 3.2, and 3.3) has, with respect to the work platform (1), two connection and bracing points distanced from each another, with an angle mounting means being provided at at least one of the two points, which prevents the legs (3.1, 3.2, and 3.3) from twisting with respect to the work platform (1) and provides it with self-supporting character, furthermore allowing a triangular distribution of forces.

Moreover, this stability condition is maintained when using the ladder on slippery floors and even when some or all the legs (3.1, 3.2, and 3.3) thereof are provided with rolling means.

In the case where the ladder is to be used on non-slippery floors and with points (4) for support on the floor, by means of high-friction corner pieces, the number of ratchets (1.8) and the number of disks (1.10) can be limited, maintaining the essence of the invention as long as each leg (3.1, 3.2, and 3.3) has the two connection points distanced from each another, for bracing same with respect to the work platform (1) and with an angle mounting means for the respective leg (3.1, 3.2 and/or 3.3) being provided at at least one of the two points.

Therefore, and for example, a practical embodiment variant that would have a very simple relationship would consist of the fact that, in a ladder such as the one depicted in the attached figures, with respect to its ladder leg (3.1), there is present, with respect to one of its journals (1.7) a solution consisting of a ratchet (1.8) and in relation to the other journal (1.7) thereof a stop (1.19); whereas with respect to the support legs (3.2 and 3.3), the rotating structure (1.6) of each of the legs will have a disk (1.10), in relation to one of the two distanced points of articulated connection to the work platform (1).

Embodiment variants which are mixed solutions conceived, among them, for slippery floors and even with support points (4) formed by rolling elements, can also be considered, and the latter is very simple, as long as the essence of the invention which lies in each leg (3.1, 3.2, and 3.3) having two connection points distanced from each another with respect to the work platform (1) for bracing same to said platform is maintained.

It should be noted that, with the embodiment of the work platform (1) according to the invention, a triangulation of the forces that the ladder must withstand is established; such that this triangulation of forces, along with the two connection points distanced from each another for the legs (3.1, 3.2, and 3.3) with an angle mounting means for the respective leg (3.1, 3.2 and/or 3.3) being provided at at least one of the two points, allows eliminating the need for flange-type elements determining, at the mid-height of the ladder, a central bracing parallel to the plane of the floor.

Furthermore, and with this solution, the legs (3.1, 3.2 and/or 3.3) can occupy positions of variable angle and the user can fix the angles at his/her own discretion, which allows the ladder to be assembled next to obstacles such as a wall and to pass over obstacles such as a stone, a barrier, a car, etc.

On the other hand, it has been envisaged for each of the journals (1.7) to incorporate adjustable fixing means (1.20) which allow introducing therein and fixing thereto the upper ends of the longitudinal members of a conventional ladder leg (3.1). In this way, the work platform (1) could be adapted to enable coupling thereto conventional lengths of ladder that can be acquired directly on the market. According to a non-limiting practical embodiment, these fixing means (1.20) can be simple screws as depicted in FIG. 21. A similar solution would be applicable to the journals (1.5), thereby giving the work platform (1) a universal character.

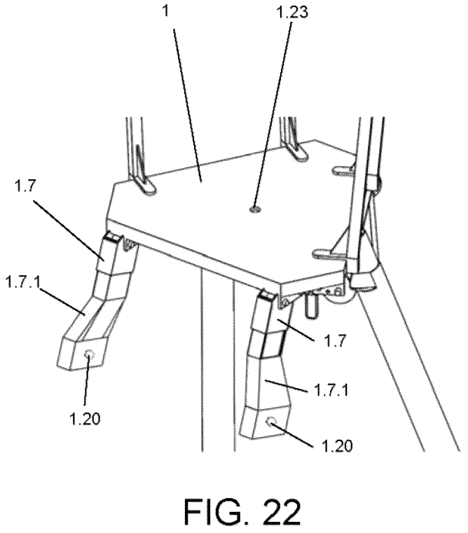

Moreover, as can be seen in FIG. 22, the journals (1.7) can incorporate adaptation pieces (1.7.1) that define a bend which can be of different angles, to enable assembling ladder legs (3.1) of different width dimensions, within that concept of universal character. The function of these auxiliary adaptation pieces (1.7.1) can be achieved by also integrating them in the journals (1.7) themselves; such that each journal (1.7) and its adaptation piece (1.7.1) form a single piece.

As can be seen in FIG. 22, the platform (1) has a central opening (1.23) which allows assembling therein a hoist-type raising or lowering element or the like; such that the portable structure can perform winch-like functions for lifting or lowering significant weights, people, etc.

The attached figures depict a platform (1) having a triangular configuration with truncated vertices, however, this configuration must be understood as a non-limiting practical embodiment in that the platform (1) may have a polygonal, circular, oval or mixtilinear base, provided that it allows establishing two connection points for connecting the legs (3.1, 3.2, and 3.3) to the platform (1), in three physical or theoretical lines, which define a triangulation. Therefore, for example, in the triangular embodiment with truncated vertices of the platform (1) depicted in the attached figures, the two connection points for each leg (3.1, 3.2 or 3.3) are situated in relation to one of the sides of the platform (1), but, for example, the platform (1) may have a circular base and below same the two connection points for the legs (3.1, 3.2, and 3.3) can be established in three possibly physical lines, through ribs or similar solutions, or theoretical lines which, however, still define a triangulation in any case.

When the legs (3.1, 3.2 and/or 3.3) have an embodiment formed by two or more telescopic tubular lengths, there will obviously be solutions for fixing the telescopic tubular lengths in the desired position. In the case where the tubular lengths are cylindrical, the tubular length of smaller diameter, which has been identified with reference number (3.4), would be fixed in the selected position thereof within the length of larger diameter (3.5); such that the legs (3.1, 3.2 and/or 3.3) adopt the required longitudinal dimension in each case.

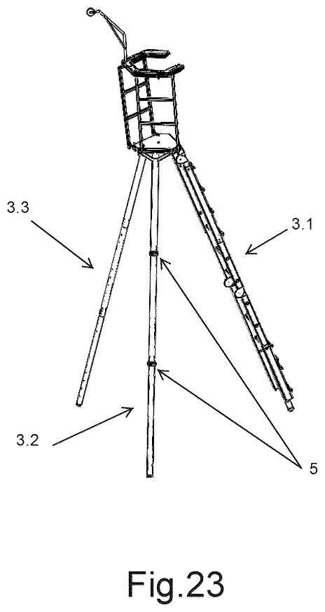

This fixing can be carried out through a very simple solution, such as providing the tubular lengths (3.4 and 3.5) with a correlation of openings to enable passing a pin through the selected pair of openings. However, this can also be achieved using more complex quick fixing mechanisms, such as the one depicted, according to a non-limiting practical embodiment, in FIGS. 23, 24, and 25 identified with reference number (5).

The quick fixing mechanism (5). For simplicity of depiction, only two quick fixing mechanisms (5) have been depicted in relation to the leg (3.2), the other two legs (3.1 and 3.3) will also have their own quick fixing mechanisms (5) if they adopt a telescopic tubular embodiment. Moreover, each leg (3.1, 3.2, and/or 3.3) will have as many quick fixing mechanisms (5) as there are pairs of tubular lengths (3.4 and 3.5) present, i.e., in this case, the leg (3.2) consists of three tubular lengths and therefore required two quick fixing mechanisms (5).

In this embodiment depicted in FIG. 23, the legs (3.2 and 3.3) would be those which would have the quick fixing mechanisms (5) and each of these legs (3.2 or 3.3), by consisting of three telescopic tubular lengths, would have two quick fixing mechanisms (5), although for simplicity of depiction, only the quick fixing mechanisms (5) of the leg (3.2) has been depicted.

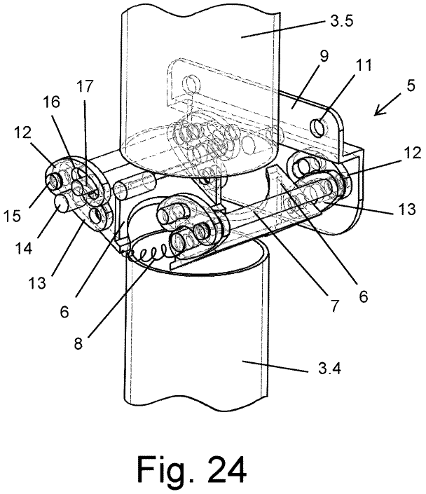

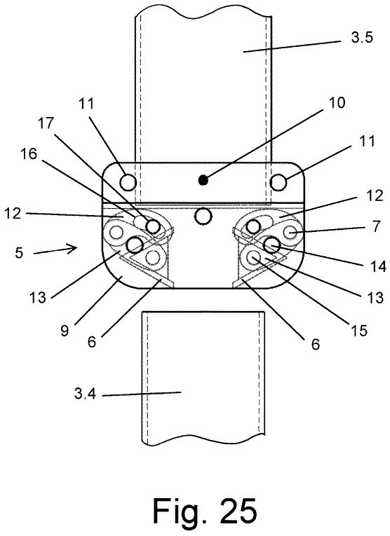

As can be seen in FIGS. 24 and 25, each quick fixing mechanism (5) consists of two identical metal plates (9) provided with openings (11) through which pass fastening screws, which allow fixing the plates (9) to the tubular length (3.5) of a larger diameter dimension, through the inside of which the tubular length (3.4) of a smaller diameter dimension can move.

Two jaws (6) are arranged between these two plates (9). Each jaw (6) is integral with a pin (14) assembled between two side flats (13), see FIG. 25. Each of the side flats (13) can swing with respect to a pin (15). A pin (7), on which the user of the portable structure object of this invention can exert a thrust, is also assembled between these side flats (13).

Two flats (12), linked to the pin (7), are also arranged on the sides of each jaw (6). Each side flat (12), see FIG. 25, has an elongated and arched opening (16) which, along with a pin (17), limits the arc movement of the side flats (12).

Each jaw (6) is kept in a stable position in which it strikes the tubular length (3.4) through the action of elastic elements (8), such as respective springs, see FIG. 24.

With all this in place, the user of this portable structure can act on the two pins (7) of each quick fixing mechanism (5) with only one hand, thrusting the structure upwards against the action of the elastic elements (8); such that the two jaws (6) separate from the tubular length ((3.4), leaving it free, so that it can move inside the tubular length (3.5). When this thrust ceases, the elastic elements (8) cause the jaws (6) to lock on the tubular length (3.4), fixing it in the position that adopts at that moment.

With this solution, the greater the tendency of the tubular length (3.4) to move, so as to be inserted into the length (3.5), the more forceful the locking of the jaws (6) on the tubular length (3.4) and the firmer the locking of the tubular length (3.4) will be, in the position that it occupies at that moment.

A pin (10) performing the functions of a stop for the movement of the length (3.4) inside the length (3.5) is assembled in the flats (11).

With this solution, in addition to achieving a quick fixing mechanism (5) capable of being operated with a single hand, the jaws (6) always occupy a position perpendicular to the longitudinal axis of the legs (3.1, 3.2 and/or 3.3) so as to be able to better perform the function thereof. Furthermore, this solution allows the jaws (6) to have accessories such as a coating or a rubber lip which prevents the telescopic tubular elements forming the legs (3.1, 3.2, and 3.3) from deteriorating.

1. A portable structure for ascending to and descending from inaccessible places comprising a self-supporting work platform, said structure formed by three legs, at least one of which is a length of ladder, the legs converging at the top where the work platform is situated, wherein the three legs (3.1, 3.2, and 3.3), consisting of the support or the corresponding supports and the length of ladder or the corresponding lengths of ladder, are joined to the work platform (1), and each of the three legs (3.1, 3.2, and 3.3) is linked to the work platform (1) at at least two connection and bracing points, distanced from each another, with an angle mounting means for the corresponding leg (3.1, 3.2 or 3.3) being provided at at least one of the two connection points of each leg (3.1, 3.2, and 3.3) to prevent the legs (3.1, 3.2, and 3.3) from twisting and to establish a triangular distribution of forces; and the portable structure thus formed does not need a bracing structure in the middle area between the different legs (3.1, 3.2, and 3.3).

2. The portable structure for ascending to and descending from inaccessible places with a self-supporting work platform according to claim 1, wherein the linking between the two connection points for each leg (3.1, 3.2, and 3.3) to the work platform (1) establishes a bracing between the leg (3.1, 3.2 or 3.3) and the work platform (1) with at least an angle mounting means for the corresponding leg (3.1, 3.2 and/or 3.3) at one of the two connection points, in order to be able to selectively fix the angles defined between the legs (3.1, 3.2, and 3.3) and the platform (1).

3. The portable structure for ascending to and descending from inaccessible places with a self-supporting work platform according to claim 1, wherein each of the support legs (3.2 and 3.3) is connected to the work platform (1) through a rotating structure (1.6) of the work platform (1) and in that the rotating structure (1.6) determines two V-shaped lengths, and parallel to one side of the work platform (1), a horizontal length through the end of which the two distanced points for the rotating connection of the support legs (3.2 and 3.3) to the work platform (1) are established.

4. The portable structure for ascending to and descending from inaccessible places with a self-supporting work platform according to claim 1, wherein the rotating structure (1.6) has, at the vertex of its two V-shaped lengths, a journal (1.5) to which there is coupled, in a fixed or detachable manner, the upper length of the corresponding support leg (3.2 and 3.3).

5. The portable structure for ascending to and descending from inaccessible places with a self-supporting work platform according to claim 1, wherein each length of ladder (3.1) is connected to the work platform (1) through two couplings thereof, distanced from each another, which establish an articulated connection, and in that the couplings are preferably two journals (1.7), into which the upper ends of the length of ladder (3.1) are inserted.

6. The portable structure for ascending to and descending from inaccessible places with a self-supporting work platform according to claim 1, wherein the work platform (1) has a flat configuration with a polygonal contour with at least three straight sides, in relation to which the three legs (3.1, 3.2, and 3.3) are assembled.

7. The portable structure for ascending to and descending from inaccessible places with a self-supporting work platform according to claim 6, wherein the work platform (1) has a flat configuration of mixtilinear contour with a stiffening reinforcement on the lower face thereof formed by stiffening ribs (1.2) extending radially from the central part.

8. The portable structure for ascending to and descending from inaccessible places with a self-supporting work platform according to claim 7, wherein the work platform (1) may have a fragmented structure, formed by three parts (1.4), each of which is connected to one of the three legs (3.1, 3.2 or 3.3).

9. The portable structure for ascending to and descending from inaccessible places with a self-supporting work platform according to claim 1, wherein the rotating structure (1.6) has a triangular base configuration with one of the sides thereof in horizontal arrangement and contiguous to the corresponding side of the work platform (1), establishing at the ends thereof articulated connection with the work platform (1) itself, and with the other two sides in a V-shaped arrangement, at the vertex of which the journal (1.5) is arranged.

10. The portable structure for ascending to and descending from inaccessible places with a self-supporting work platform according to claim 1, wherein at least the support legs (3.2 and 3.3) incorporate, in relation to one of the articulation points thereof, means for fixing the position of the support legs (3.2 and 3.3) in arrangements changing the angle formed with respect to the floor by 360°, said means preferably being formed by a disk (1.10), with openings (1.11) arranged circumferentially, each opening (1.11) defining a different angular position of the support arms (3.2 and 3.3).

11. The portable structure for ascending to and descending from inaccessible places with a self-supporting work platform according to claim 1, wherein at least in relation to the ladder leg (3.1) there is a ratchet system (1.8) for establishing at least two stable positions of the journals (1.7), an operative position, in which the journals (1.7) are deployed, and another folded position, in which the journals (1.7) are stowed away below the platform (1).

12. The portable structure for ascending to and descending from inaccessible places with a self-supporting work platform according to claim 1, wherein at least in relation to one of the two journals (1.7) there is a stop element (1.19) acting in the deployed position of the journal (1.7).

13. The portable structure for ascending to and descending from inaccessible places with a self-supporting work platform according to claim 1, wherein each of the journals (1.7) has been envisaged to incorporate adjustable fixing means (1.20) which allow introducing therein and fixing thereto the upper ends of the longitudinal members of a conventional ladder leg (3.1).

14. The portable structure for ascending to and descending from inaccessible places with a self-supporting work platform according to claim 1, characterised in that at least one of the journals (1.7) has been envisaged to incorporate, in an auxiliary manner or as a single piece therewith, an adaptor (1.7.1), in order to be able to adapt the journals (1.7) to the different width dimensions of the ladder legs (3.1).

15. The portable structure for ascending to and descending from inaccessible places with a self-supporting work platform according to claim 1, wherein an opening (1.23) or a similar solution has been envisaged in the central area of the platform (1) for assembling a load lifting and lowering device, acting as a winch.
